(19) United States
(12) Patent Application Publication
(10) Pub. No.: US 2007/0277741 A1
(43) Pub. Date: Dec. 6, 2007

(54) Disposable Litter Scoop

(76) Inventors: Joel Delman, Chicago, IL (US); Lisa Yanz, Chicago, IL (US); Carolyn Rose, Chicago, IL (US)

Correspondence Address: Heather A. Kartsounes, Suite 210, 520 W. Erie Street, Chicago, IL, 60610, US

(21) Appl. No.: 11/750,738

(22) Filed: May 18, 2007

Related U.S. Application Data
(60) Provisional application No. 60/747,553, filed on May 18, 2006.

(51) Int. Cl. A01K 29/00

(52) U.S. Cl. 119/166

(57) ABSTRACT

A disposable this waste/debris removal scoop comprising a replaceable head and a frame capable of receiving said replaceable head. The frame receives the replaceable head and holds the head into place by way of a snap feature comprising tabs. The tabs allow for the replaceable head to be snapped on or off as the user desires.

### REFERENCE TO RELATED APPLICATION

This application is a non-provisional application based of the U.S. Provisional Application No. 60/747,553 filed on May 18, 2006. This prior application is hereby incorporated by reference herein.

### FIELD OF THE INVENTION

This invention relates to scoops for waste removal. More specifically, it relates the scoops for waste removal with disposable, replaceable heads.

### BACKGROUND OF THE INVENTION

Scoops for waste removal, such as an animal litter scoop, are well known. These scoops are used to remove waste products or other debris from an animal's litter box. Waste must be removed regularly to ensure a clean environment for the animal. This removal process is typically an undesirable task for a pet owner as it is can be messy and unappealing. As such, scoops such as those seen in U.S. Pat. Nos. 6,312,029 B1, D507,083, 6,641,188, and D429,349 have been developed to make this removal process a bit easier on pet owners.

Typical waste removal scoops experience a significant amount of wear and tear. These scoops are used to sift through litter and become can become covered with litter, dust, and animal waste. These contaminated waste removal scoops are very unsanitary and users find it difficult to find discreet places to store the scoops. As such, when a waste removal scoop becomes too undesirable and unsanitary to keep, a user will typically try to wash the scoop or will simply throw it away.

Since these scoops are known to be disposed of quite frequently, they are commonly made out of an inexpensive, lightweight plastic that is simply molded and slotted to do the job of sifting and scooping. Most litter scoops are made very cheaply and of material that is not extremely durable. Since that is the case, vigorous washing and scrubbing of these scoops tends to break or otherwise damage the scoops. When users simply throw the scoops away instead of cleaning them, they will incur the cost of a replacement scoop. There is a demand to solve these problems and this invention can aid users in dealing with these common situations.

### SUMMARY OF THE INVENTION

This invention aims to solve or at least alleviate the above-mentioned problems in a variety of ways. Therefore, this waste/debris removal scoop comprises:

a replaceable head; and

a frame capable of receiving said replaceable head.

The frame receives the replaceable head and holds the head into place by way of a snap feature comprising tabs. The tabs allow for the head to be snapped on or off as the user desires. Preferably, the head will be slotted in some manner to allow for proper sifting of the litter.

The replaceable head will comprise of a material, such as a thin plastic, that is preferably a styrene or polypropylene. This material must preferably be strong enough to achieve the scooping and sifting functions that a litter box scoop must achieve. However, one skilled in the art will recognize that many materials, especially those of a biodegradable nature may be desirable and can be used to achieve the function of a replaceable head on a waste/debris removal scoop.

In order to remove a used head from the frame, a user simply needs to pull the flap of the head. This pulling motion will allow for the head to be snapped off the tabs. The flap ideally will not have come into contact with litter or animal waste so the removal process is sanitary for the user. The head can be then be disposed of.

In order to replace a head onto the frame, a user simply needs to align the head with the frame and press onto the tabs snapping the head in place. Once the head is in place, the scoop is able to be used once again as a clean and sanitary scoop.

The process of the removal and replacement of the head can be repeated as often or as many times as the user desires.

This waste/debris removal scoop can also comprise a scent feature. Often times, litter boxes can have unpleasant odors that can be eliminated or at the very least masked by a scent feature attached this removal scoop. This scent feature may be a simple scent element attached onto the head or frame, be added into the material of the head, or it may be a spray feature that allows for some scent to be left behind in the litter box. The scent feature is preferably a removable and replaceable feature to maintain the removal scoop's original integrity and function with the added benefit of a pleasant scent feature.

While this invention is envisioned for use in a litter box setting, this is not the only place where such a waste/debris removal scoop can be used. One skilled in the art will recognize that a removal scoop with a replaceable head has many settings where it can be useful.

Other advantages and aspects of the present invention will become apparent upon reading the following description of the drawings and the detailed description of a preferred embodiment of the invention.

### DETAILED DESCRIPTION OF THE DRAWINGS

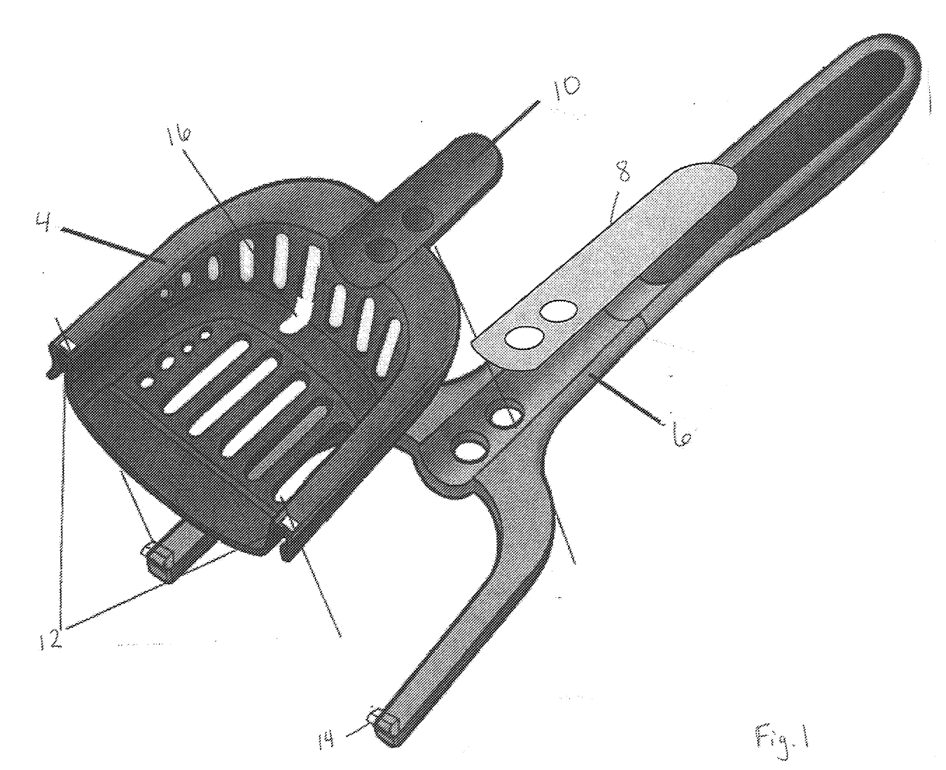

FIG. 1 depicts an exploded view of the waste/debris removal scoop with the scent feature.

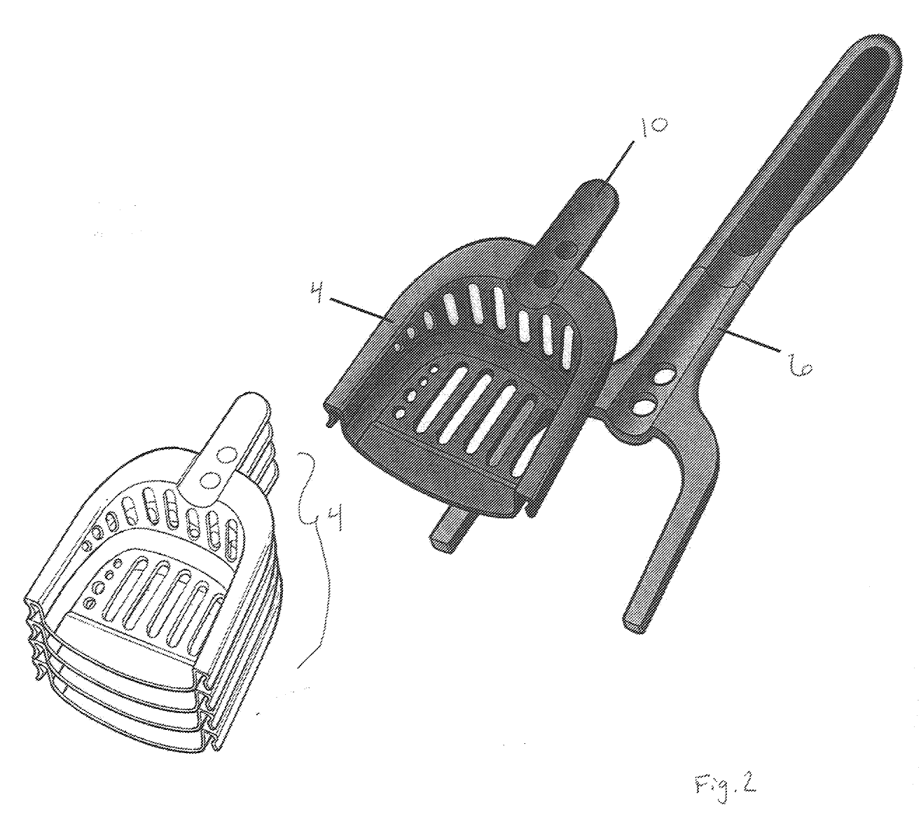

FIG. 2 is an exploded view of the waste/debris removal scoop with a group of replaceable heads but without the scent feature.

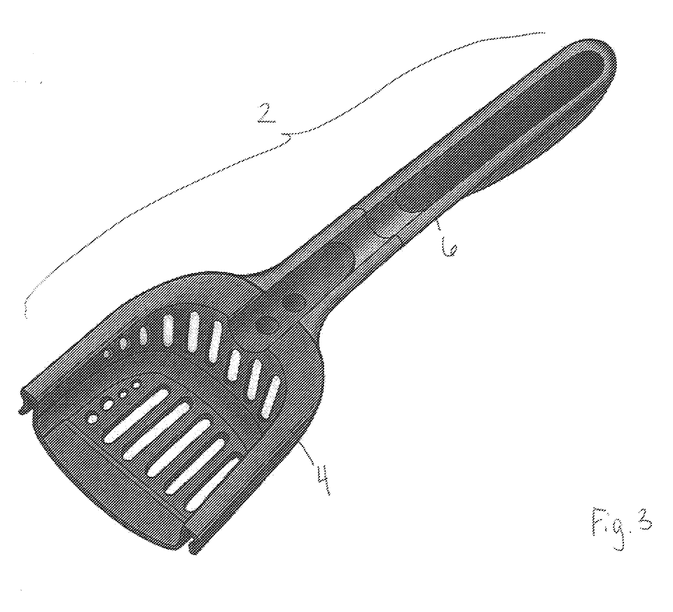

FIG. 3 is an assembled view of the waste/debris removal scoop.

### DETAILED DESCRIPTION OF THE PREFERRED EMBODIMENT

In its preferred embodiment, this invention describes a waste/debris removal scoop 2 comprising a replaceable head 4 and a frame 6 capable of receiving the head 4. The head 4, can be removed or replaced on the frame 6 by ways of a snap feature comprising tabs 14. The head 4 will be preferably slotted with slots 16 to allow for sifting.

The removal scoop 2 may further comprise a scent feature that can be useful when using the removal scoop 2 in a setting with unpleasant odors, such as the litter box setting. This scent feature may be a simple scent element 8 as seen in FIG. 1 pressed between the head 4 and the frame 6. The scent feature may also be a spray scent feature (not shown) that can spray the litter in order to remove or mask unpleasant odors. The scent feature 8 may also be built inside of the head 4.

When a user wishes to replace the head 4 on the removal scoop 2, the user simply needs to lift the flap 10 of the head 4 and pull away from the frame 6. This pulling motion releases the head 4 from the tabs 14. To replace the head 4, a user needs to line up the new head 4 with the frame 6. The tab receiving holes 12 should be lined up with the tabs 14 and the head 4 can be pressed into place. Once this occurs, the removal scoop 2, is able to be used again as a new removal scoop 2 with a clean and sanitary head 4.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

What is claimed is:

1. A waste/debris removal scoop comprising:
a replaceable head; and
a frame capable of receiving said replaceable head.

2. A waste/debris removal scoop as in claim 1, further comprising a scent feature.

3. A waste/debris removal scoop as in claim 2, wherein said scent feature comprises scent spray or scent element attached to said replaceable head or said frame.

4. A waste/debris removal scoop as in claim 1, wherein said replaceable head is slotted.

5. A waste/debris removal scoop as in claim 1, wherein said replaceable head comprises of a material of biodegradable nature.

6. A waste/debris removal scoop as in claim 1, wherein said frame receives said replaceable head by way of a snap feature comprising tabs.
